(19) United States
(12) Patent Application Publication
(10) Pub. No.: US 2004/0265660 A1
(43) Pub. Date: Dec. 30, 2004

(54) Cooling device for electrical systems and use of polymers in cooling circuits

(76) Inventors: Gerhard Reuschel, Liederbach (DE); Frank Reil, Seecheim (DE); Michael Hoerr, Weinheim (DE)

Correspondence Address: CONNOLLY BOVE LODGE & HUTZ, LLP, P O BOX 2207, WILMINGTON, DE, 19899, US

(21) Appl. No.: 10/494,688

(22) PCT Filed: Oct. 31, 2002
(86) PCT No.: PCT/EP02/12155

(30) Foreign Application Priority Data
Nov. 7, 2001 (DE) 101 54 242.9

(51) Int. Cl. H01M 8/04; F28F 1/00

(52) U.S. Cl. 429/26; 165/177

(57) ABSTRACT

The use of polyarylene sulfides or liquid-crystalline polyesters is described in cooling devices for electrical equipment. The use of these polymers can ensure that the electrical conductivity of insulating coolant fluids remains low in continuous operation. Fuel cells are particularly suitable electrical equipment.

The present invention relates to the use of selected polymers in cooling circuits in which the coolant is in direct contact with live components, and also to the use of these polymers in cooling circuits of this type.

Electrical equipment, such as electrochemical elements for obtaining electrical energy and heat via an electrochemical reaction with continuous supply of the reactants, is currently undergoing vigorous continued development. One of the aims is use as energy source in motor vehicles, or use in decentralized combined heat and power plants, or in transportable electrical generators.

Depending on design and operating point, about 30-70% of the energy present in fuel can be converted into electrical energy. This level of electrical efficiency is then complemented by 70-30% of heat which is liberated during the energy-conversion process. This heat has to be dissipated from the system in order to avoid overheating during operation. At the same time, this energy can be utilized as a heat source for heating purposes. The functioning of such electrochemical energy converters therefore has to involve a cooling system which uses heat-transfer fluids to dissipate the heat losses from the reaction and maintains the system at constant operating temperature. It should be noted here that the heat- transfer medium has to be an electrical insulator, since otherwise contact with live components can cause short circuiting or power losses.

Another factor to be considered in the case of the use in fuel cell systems is minimization of the amount of metal ions which can migrate into the coolant. The reaction in particular of the electrolyte layer of polymer electrolyte membrane (PEM) fuel cells involves power losses on exposure to metal ions.

In addition, the coolant should be inexpensive, non-toxic, and easy to handle. Mixtures composed of water with mono- or polyhydric, or polymeric, alcohols meet these requirements. For example, mixtures of water with glycols have proven successful in use as heat-transfer media in conventional systems.

The significance of low conductivity of the coolant has been recognized previously. JP-A-90-92,314 describes a fuel cell which has a solid electrolyte and in which the diffusion of chromium components is minimized via the use of dried air.

The use of coated metal tubes as heat-exchanger pipes has been described, for restricting the conductivity of the coolant and maintaining its purity. U.S. Pat. No. 3,964,930 describes the coating of the heat-exchanger tubes with fluoropolymers.

WO-A-98/40,655 describes the use of fluoropolymers for the external coating of thermally conductive tubes composed of copper or of stainless steel as conductive material for use in fuel cells. To this end, one tube is passed into another, both tubes being composed of these materials, and the outer tube is applied to the surface of the inner tube via shrinkage.

The use of ion exchangers or ion filters in cooling circuits has also previously been described. These additional devices are intended to keep the conductivity of the coolant low and help to reduce its ion content.

Systems of this type are described by way of example in JP-A-2000-208, 157; JP-A-80/83,991 and WO-A-1998-2247856.

Other specifications, such as JP-A-2000-113,900 or EP-A-1,056,148, disclose a cooling system, but do not give detail of the selection of material for the components.

The known materials or combinations of materials are expensive and/or complicated to process, or use has to be made of additional devices, such as ion exchangers. These measures lead in turn to increased cost, because the filter cartridges of the ion exchangers become exhausted in continuous operation and have to be replaced.

There continues therefore, to be a requirement for powerful and low-cost cooling systems which ensure that the conductivity of the coolant does not increase.

It was therefore an object to develop cooling systems for electrical systems where the conductivity of the coolant liquid does not increase, or increases only insignificantly, during operation. To this end, it was necessary to find suitable materials which have high mechanical strength combined with very high chemicals resistance with respect to fluids in cooling circuits.

The materials required are moreover to be suitable for mass-production processes, in order to keep the production costs of these cooling systems low.

The object is achieved via the inventive cooling circuit, and also via the use of selected materials.

The invention provides a cooling device for electrical equipment through which an electrically insulating coolant fluid is circulated, encompassing supply and discharge lines for a coolant fluid which is in contact with the live components, wherein at least the components of the cooling device which are in contact with the coolant are composed of polyarylene sulfide and/or of liquid-crystalline polyester, or have a coating composed of these polymers.

For the purposes of this description, electrical equipment is any of the equipment which has live components and which is cooled by means of an electrically insulating fluid.

Examples of electrical equipment where heat losses have to be dissipated are transformers, inverters, electrical motors, or electrochemical elements for the generation of electrical energy, in particular fuel cells.

The cooling devices are generally composed of a tube system for the supply and discharge of the fluid, at least in the region of the live components, for cooling these, one or more heat exchangers for exchange of the heat generated and cooling of the fluid, and/or reservoir(s) for the fluid, and also pumps which circulate the fluid in the cooling device, and, where appropriate, sensors, which may be components of a control loop used, for example, to influence the circulation rate of the fluid in the circuit.

The fluid used may comprise any liquid, gaseous, or supercritical medium which has no, or low, electrical conductivity and which is capable of dissipating, as specified, the heat generated. Typical conductivities of the fluid are in the range below 10 μS/cm, preferably below 5 μS/cm. Supercritical media, or in particular liquids, are preferred because they have good heat capacity. Very particular preference is given to a mixture composed of water and alcohol, in particular a glycol, such as ethylene glycol and/or polyethylene glycol, whose electrical conductivity is <10 μS/cm, in particular <5 μS/cm.

The components of the cooling device which are in contact with the live components and/or come into close proximity with these are composed, at least in the region of these live components of the electrical equipment, of polyarylene sulfide and/or liquid-crystalline polyester, or comprise a coating composed of these polymers.

All of the components of the cooling device which are in contact with the live components or come into close proximity with the same may be entirely composed of these polymers. Instead of components entirely formed from these polymers, it is preferable to use components composed of a combination of a metal, such as copper, stainless steel, or aluminum, with a coating composed of these polymers.

These components of the cooling device therefore encompass at least one layer composed of a molding composition which is composed of a liquid-crystalline polyester and/or of a polyarylene sulfide. This layer may also comprise other additives alongside the polymer, e.g. fibrous reinforcing materials, such as glass fibers, carbon fibers, boron fibers or whiskers; or fillers, such as talc or calcium carbonate, or other auxiliaries and additives conventional per se for the processing of the polymers, as long as these additives do not adversely affect the long-term stability of the fluid.

The molding compositions used according to the invention may also be combined, where appropriate, with other plastics and/or metals alongside polyarylene sulfide or liquid-crystalline polyester.

The polyarylene sulfide used according to the invention are known per se. These are usually linear polymers containing the structural repeat unit of the formula I

—Ar—S— (I),

where Ar is a divalent aromatic radical, preferably meta- and/or para-phenylene. Polyarylene sulfides may be prepared via dihalogenated aromatic compounds. Preferred dihalogenated aromatic compounds are p-dichlorobenzene, m-dichlorobenzene, 2,5-dichlorotoluene, p-dibromobenzene, 1,4-dichloronaphthalene, 1-methoxy-2,5-dichlorobenzene, 4,4′-dichlorobiphenyl, 3,5-dichlorobenzoic acid, 4,4′-dichlorodiphenyl ether, 4,4′-dichlorodiphenyl sulfone, 4,4′-dichlorodiphenyl sulfoxide, and 4,4′-dichlorodiphenyl ketone. Small amounts of other halogenated compounds, such as trihalogenated aromatics, may be used for precise control of the properties of the polymer.

According to the invention, the preferred polyarylene sulfide used is polyphenylene sulfide.

Polyphenylene sulfide (PPS) is a partially crystalline polymer with the formula II

—(C₆H₄—S)ₙ— (II)

where n>1 and the polymer has a molar mass (Mw) greater than 200 g/mol.

It is also possible to use crosslinked polyarylene sulfides; preferred types are linear, in particular those derived to an extent greater than 90 mol %, based on the arylene units, from p-phenylene.

Particular preference is given to the use of linear polyphenylene sulfides whose melt viscosities are from 30 to 1500 Pa*sec (measured at 316° C. with a shear gradient of 400/sec to ASTM D3835).

According to the invention, it is also possible to use the liquid-crystalline plastics known per se. There are no restrictions on the type of materials used, but advantageous materials are those which can be processed thermoplastically. By way of example, particularly suitable materials are described in Saechtling, Kunststoff-Taschenbuch [Plastics Handbook], Hanser-Verlag, 27^{th} edition, pp. 517-521, incorporated herein by way of reference. Materials which may be used with advantage are polyterephthalates, polyisophthalates, PET-LCP, PBT-LCP, Poly(m-phenyleneisophthalimide), PMPI-LCP, poly(p-phenylenephthalimide), PPTA-LCP, polyarylates, PAR LCP, polyester carbonates, PEC-LCP, polyazomethines, polythioesters, polyesteramides, polyesterimides, and polyarylene oxides. Particularly advantageous materials are liquid-crystalline plastics based on p-hydroxybenzoic acid, e.g. copolyesters and copolyesteramides. Liquid-crystalline plastics to be used with very particular advantage are generally fully aromatic polyesters which form anisotropic melts and have average molar masses (M_{w}=weight-average) of from 2000 to 200,000, preferably from 3,500 to 50,000, and in particular from 4000 to 30,000, g/mol. U.S. Pat. No. 4,161,470, incorporated herein by way of reference, describes a suitable class of liquid-crystalline polymers. These are naphthoyl copolyesters having structural repeat units of the formulae III and IV

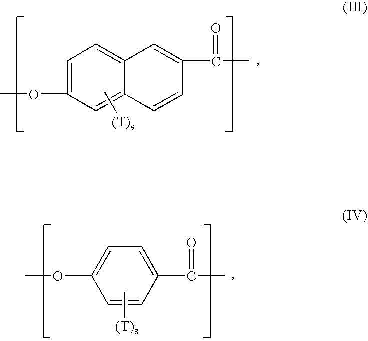

where T has been selected from an alkyl radical, an alkoxy radical, in each case having from 1 to 4 carbon atoms, or a halogen, preferably chlorine, bromine, or fluorine, s is zero or an integer 1, 2, 3, or 4, and in the case of more than one radical T these are independent of one another and identical or different. The naphthoyl copolyesters contain from 10 to 90 mol %, preferably from 25 to 45 mol %, of structural units of the formula I and from 90 to 10 mol %, preferably from 85 to 55 mol %, of structural units of the formula II, the proportions of the structural units of the formulae I and II giving a total of 100 mol %.

EP-A-0 278 066 and U.S. Pat. No. 3,637,595, incorporated herein by way of reference, describe other liquid-crystalline polyesters suitable for the purposes of the invention.

Surprisingly, it has been found that neither polyarylene sulfides (“PPS”), such as Fortron®, nor liquid-crystalline polyesters substantially increase the conductivity of insulating coolant fluids, such as glycol/water mixtures, even at elevated temperatures.

The present invention also provides the use of polyarylene sulfide and/or liquid-crystalline polyester in cooling circuits which are in contact with live components of electrical equipment. The materials which can be used according to the invention are particularly suitable for producing components for heat exchangers, coolers, pumps, sensors, and valves for such cooling circuits.

The examples below illustrate the invention but do not limit the same.

### INVENTIVE EXAMPLE 1

50 grams of unreinforced poly(p-phenylene sulfide) (Fortron®) pellets were stored at 80° C. in 500 ml of a coolant liquid (deionized water: glycol 1:1; parts by volume). The conductivity of the solution was determined at regular intervals with the aid of a commercially available conductivity meter (manufactured by Knick).

As comparison, a blank specimen without any pellet content was tested.

Even after a long period, the conductivity of the heat-transfer fluid remained below 5 μS/cm.

| Temperature | Storage time | Conductivity |
|---|---|---|
| (° C.) | (h) | (μS/cm) |
| RT | 0 | 0.16 |
| 80 | 4 | 0.32 |
| 80 | 24 | 0.65 |
| 80 | 48 | 0.96 |
| 80 | 72 | 1.02 |
| 80 | 96 | 1.03 |
| 80 | 120 | 1.03 |
| 80 | 144 | 1.11 |
| 80 | 168 | 1.14 |

### COMPARATIVE EXAMPLE 1×

50 grams of 5 mm×1 mm aluminum chips were stored as described in Inventive Example 1 in a glycol/water mixture, and the conductivity of the liquid was determined. As can be seen in Table 2, the conductivity rises sharply even after just a short period.

| Temperature | Storage time | Conductivity |
|---|---|---|
| ° C. | (h) | (μS/cm) |
| RT | 0 | 8.63 |
| 80 | 4 | 81.49 |
| 80 | 24 | >200 |
| 80 | 48 | >200 |
| 80 | 72 | >200 |
| 80 | 96 | >200 |
| 80 | 120 | >200 |
| 80 | 144 | >200 |
| 80 | 168 | >200 |

### INVENTIVE EXAMPLE 2

50 g of Fortron® reinforced with 40% of glass fiber were stored as described in Inventive Example 1, and the conductivity of the heat-transfer fluid was determined. The results are shown in Table 3 below.

| Temperature | Storage time | Conductivity |
|---|---|---|
| (° C.) | (h) | (μS/cm) |
| RT | 0 | 0.08 |
| 80 | 6 | 0.36 |
| 80 | 24 | 0.76 |
| 80 | 48 | 1.15 |
| 80 | 72 | 1.53 |
| 80 | 96 | 1.8 |
| 80 | 120 | 1.92 |
| 80 | 144 | 1.98 |
| 80 | 168 | 2.01 |

### COMPARATIVE EXAMPLE 2×

50 grams of 5 mm×1 mm copper chips were stored as described in Inventive Example 1 in a glycol/water mixture, and the conductivity of the liquid was determined. As can be seen in Table 4, the conductivity rises sharply even after just a short period.

| Temperature | Storage time | Conductivity |
|---|---|---|
| (° C.) | (h) | (μS/cm) |
| RT | 0 | 0.04 |
| 80 | 4 | 1.28 |
| 80 | 24 | 3.14 |
| 80 | 48 | 5.88 |
| 80 | 72 | 8.03 |
| 80 | 96 | 10.49 |
| 80 | 120 | 12.74 |
| 80 | 144 | 14.87 |
| 80 | 168 | 17.84 |

### INVENTIVE EXAMPLE 3

50 g of an unreinforced liquid-crystalline polyester (Vectra®)) were stored as described in Inventive Example 1, and the conductivity of the heat-transfer fluid was determined. The results are shown in Table 5 below.

| Temperature | Storage time | Conductivity |
|---|---|---|
| (° C.) | (h) | (μS/cm) |
| RT | 0 | 0.09 |
| 80 | 4 | 0.16 |
| 80 | 24 | 0.19 |
| 80 | 48 | 0.29 |
| 80 | 72 | 0.46 |
| 80 | 96 | 0.69 |
| 80 | 120 | 0.77 |
| 80 | 144 | 0.93 |
| 80 | 168 | 0.99 |

### COMPARATIVE EXAMPLE 3

50 grams of glass-fiber-reinforced PPA (polyphthalamide, Amodel von BP Amoco) were stored in a glycol/water mixture as described in Inventive Example 1, and the conductivity of the liquid was determined. As can be seen from Table 6, the conductivity rises sharply after just a short period.

| Temperature | Storage time | Conductivity |
|---|---|---|
| (° C.) | (h) | (μS/cm) |
| RT | 0 | 0.34 |
| 80 | 4 | 23.39 |
| 80 | 24 | 54.87 |
| 80 | 48 | 72.19 |
| 80 | 72 | 85.29 |
| 80 | 96 | 95.91 |
| 80 | 120 | >200 |
| 80 | 144 | >200 |
| 80 | 168 | >200 |

### COMPARATIVE EXAMPLE 4

50 grams of unreinforced polyamide (nylon-6,6) were stored in a glycol/water mixture as described in Inventive Example 1, and the conductivity of the liquid was determined. As can be seen in Table 7, the conductivity rises sharply after just a short period.

| Temperature | Storage time | Conductivity |
|---|---|---|
| (° C.) | (h) | (μS/cm) |
| RT | 0 | 0.53 |
| 80 | 4 | 19.49 |
| 80 | 24 | 45.47 |
| 80 | 48 | 55.79 |
| 80 | 72 | 60.49 |
| 80 | 96 | 62.71 |
| 80 | 120 | 64.06 |
| 80 | 144 | 64.90 |
| 80 | 168 | 65.44 |

### COMPARATIVE EXAMPLE 5

50 grams of unreinforced high-temperature polyamide (HTN high temperature nylon from DuPont) were stored in a glycol/water mixture as described in Inventive Example 1, and the conductivity of the liquid was determined. As can be seen in Table 8, the conductivity rises sharply after just a short period.

| Temperature | Storage time | Conductivity |
|---|---|---|
| (° C.) | (h) | (μS/cm) |
| RT | 0 | 1.38 |
| 80 | 4 | 10.10 |
| 80 | 24 | 20.27 |
| 80 | 48 | 25.79 |
| 80 | 72 | 29.79 |
| 80 | 96 | 32.81 |
| 80 | 120 | 34.86 |
| 80 | 144 | 36.20 |
| 80 | 168 | 37.94 |

1. A cooling device for electrical equipment through which an electrically insulating coolant fluid is circulated, which comprises a pipe system and/or heat exchangers and/or reservoirs and/or pumps and/or sensors, and also supply and discharge lines for a coolant fluid which is in contact with the live components, wherein at least the components of the cooling device which are in contact with the coolant are composed of polyarylene sulfide and/or of liquid-crystalline polyester, or have a coating composed of these polymers.

2. The cooling device as claimed in claim 1, wherein the electrical equipment comprises a fuel cell.

3. The cooling device as claimed in claim 1, wherein the electrically insulating coolant fluid is a mixture composed of water and an alcohol, with an electrical conductivity of less than 5 μS/cm.

4. The cooling device as claimed in claim 1, wherein, at least in the region of the live components of the electrical equipment, the components of the cooling device which are in contact with the electrically insulating coolant fluid are composed of polyarylene sulfide or of liquid-crystalline polyester, or have a coating composed of these polymers.

5. The cooling device as claimed in claim 4, wherein the polyarylene sulfide is poly(p-phenylene sulfide).

6 and 7. cancelled.

8. Coolant circuits which are in contact with live components of electrical equipment which comprise polyarylene sulfide or liquid-crystalline polyester or a mixture thereof.

9. The cooling circuits as claimed in claim 8, wherein the electrical equipment comprises a fuel cell.

10. The cooling device as claimed in claim 1, wherein the electrical equipment comprises a fuel cell with polymer electrolyte membranes.

11. The cooling device as claimed in claim 1, wherein the electrically insulating coolant fluid is a mixture composed of glycol with an electrical conductivity of less than 5 μS/cm.

12. The cooling device as claimed in claim 1, wherein the electrically insulating coolant fluid is a mixture composed of ethylene glycol with an electrical conductivity of less than 5 μS/cm.

13. The cooling device as claimed in claim 1, wherein the electrically insulating coolant fluid is a mixture composed of propylene glycol with an electrical conductivity of less than 5 μS/cm.
